(19) United States
(12) Patent Application Publication
(10) Pub. No.: US 2005/0079857 A1
(43) Pub. Date: Apr. 14, 2005

(54) Mobile communication system, control server and mobile communication method

(75) Inventors: Yohei Umezawa, Tokyo (JP); Yoshio Nitta, Tokyo (JP)

Correspondence Address: OSTROLENK FABER GERB & SOFFEN, 1180 AVENUE OF THE AMERICAS, NEW YORK, NY, 100368403, US

(73) Assignee: NEC Corporation

(21) Appl. No.: 10/961,137

(22) Filed: Oct. 8, 2004

(30) Foreign Application Priority Data
Oct. 10, 2003 (JP) 352556/2003

(51) Int. Cl. H04M 11/00

(52) U.S. Cl. 455/406; 455/408

(57) ABSTRACT

A mobile communication system, a control server and a mobile communication method, in which a particular communication cost separate from a normal communication cost can be set to communications between mobile communication terminals locating in a specified area, and a conventional infrastructure can be effectively utilized by using a new add-on device onto the existing switched mobile network without its large improvement. In response to a request to carry out a communication from one mobile communication terminal to another mobile communication terminal using a particular accounting system, the control server determines whether of not the mobile communication terminals locate within the respective specified areas to send allowance of the communication using the particular accounting system to the mobile communication terminal on a sending side.

### TECHNICAL FIELD

The present invention relates to a mobile communication system for carrying out communications between mobile terminals via a mobile communication network, a control server used for the mobile communication system and a mobile communication method using the mobile communication system and the control server, and more particularly to a mobile communication system, a control server and a mobile communication method, in which a particular communication cost separate from a normal communication cost can be set to communications between the mobile terminals locating in a specified area.

### BACKGROUND OF THE INVENTION

A mobile communication service for connecting a mobile communication terminal to another mobile communication terminal or a fixed terminal on a public switched telephone network linked to a mobile communication network has now come into widespread use.

Such a mobile communication service has implemented by allowing a communication carrier to construct a mobile communication network comprising a communication network (switched mobile network) and a base station connected to the communication network and assigning mobile communication terminals of users to the base station.

In recent years, in mobile communication business, when in combination with needs of the users to want reduction of telephone call costs and the communication carrier to want service differentiation from other carriers, the mobile terminals are assigned to a specified area, it has been requested to realize an accounting system enabling reduction or exemption of the telephone call costs.

For instance, when a user locating in an office building of his company communicates with a mobile terminal of another staff member locating in the same office building and such an accounting system enabling the reduction or the exemption of the telephone call costs can be realized, the user can save the telephone call cost and the carrier can increase the number of customers by providing this service.

In the prior art, a mobile telephone system for providing such service has been proposed, as disclosed in Japanese Patent publication No. Hei 8-502391.

However, in this conventional mobile telephone system, a particular device is added within a switched mobile network to separate telephone calls within a certain group from telephone calls out of the group. In this case, the existing switched mobile network including switching stations must be largely improved to utilize a conventional infrastructure.

### SUMMARY OF THE INVENTION

It is therefore an object of the present invention to provide a mobile communication system in view of the aforementioned problems of the prior art, which is capable of setting a particular communication cost separate from a normal communication cost to communications between mobile terminals locating in a specified area by using a particular add-on device mounted onto an existing switched mobile network, and which can use a conventional infrastructure without its large improvement.

It is another object of the present invention to provide a control server used for the mobile communication system, which is capable of setting a particular communication cost separate from a normal communication cost to communications between mobile terminals locating in a specified area by using a particular add-on device mounted onto an existing switched mobile network, and which can use a conventional infrastructure without its large improvement.

It is still another object of the present invention to provide a mobile communication method using a mobile communication system and a control server used for it, which is capable of setting a particular communication cost separate from a normal communication cost to communications between mobile terminals locating in a specified area by using a particular add-on device mounted onto an existing switched mobile network, and which can use a conventional infrastructure without its large improvement.

In accordance with a first aspect of the present invention, there is provided a mobile communication system, comprising: a mobile communication network including a plurality of base stations; mobile communication terminals assigned to any of the base stations, which carrying out communications via the mobile communication network; and an accounting device for accounting communication costs to the communications of the mobile communication terminals, further comprising: a control server connecting to all the base stations included in a group including at least one base station and to the accounting device, which applies a particular accounting system to a communication from any mobile communication terminal assigned to a specified base station included in the group to another mobile communication terminal assigned to the specified base station included in the group, each mobile communication terminal including: a first sending device for sending information showing the base station that its own terminal is assigned to the control server; and a requesting device for requesting a communication with another mobile communication terminal using the particular accounting system from the control server, the control server including: first storage means for storing terminal belonging information representing that any of the base stations included in the group is the specified base station for the respective mobile communication terminals; second storage means for storing terminal locating information representing the base station that the respective mobile communication terminals are now assigned to; first determining means for determining whether or not the mobile communication terminals on sending and receiving sides are assigned to the respective base stations on the basis of the terminal belonging information and the terminal locating information stored in the first and second storage means when the mobile communication terminal requests a start of the communication using the particular accounting system; communication means for sending information representing that the communication using the particular accounting system is possible to the mobile communication terminal on the sending side when the mobile communication terminals on the sending and receiving sides are assigned to the respective specified base stations; and transmit means for sending particular account applying information representing that the particular accounting system is applied to a communication cost of the communication using the particular accounting system to the accounting device when any mobile communication terminal carries out the communication using the particular accounting system.

In the first embodiment of the present invention described above, it is preferable that the particular account applying information is information representing either exemption or reduction of the cost for the communication carried out by the mobile communication terminal. In this way, an increase of users of the mobile communication system according to this embodiment and an increase of customer gathering force to places base stations are installed can be performed.

Further, in the first embodiment of the present invention described above, it is preferable that the mobile communication terminal further includes: a second sending device for sending a user identification specifying a user of his own mobile communication terminal when the mobile communication terminal requests the communication using the particular accounting system from the control server, and the control server further includes: register means for storing user information representing that which of the base station included in the group is usable for each user as the specified base station; and second determining means for determining whether or not the particular accounting system is applied to the communication of the mobile communication terminal requesting the communication using the particular accounting system on the basis of the user identification obtained from the mobile communication terminal.

In any construction of the first embodiment of the present invention described above, it is preferable that the control server still further includes: delivery means for delivering the terminal locating information related to any mobile communication terminal to another mobile communication terminal requesting the delivery of the terminal locating information. By obtaining the information showing that another mobile communication terminal locates within the area of which base station by the mobile communication terminal, the user can know before the communication start that the communication using the particular accounting system can be possible for which mobile communication terminals.

In accordance with a second aspect of the present invention, there is provided a control server used for a mobile communication system comprising a mobile communication network including a plurality of base stations; mobile communication terminals assigned to any of the base stations, which carrying out communications via the mobile communication network; and an accounting device for accounting communication costs to the communications of the mobile communication terminals, the control server connecting to all the base stations included in a group including at least one base station and to the accounting device, the control server comprising: first obtaining means for obtaining terminal locating information representing the base station that its own mobile communication terminal is assigned to from the respective mobile communication terminals; first storage means for storing terminal belonging information representing that any of the base stations included in the group is the specified base station for the respective mobile communication terminals; second storage means for storing the terminal locating information of the respective mobile communication terminals; first determining means for determining whether or not the mobile communication terminals on sending and receiving sides are assigned to the respective base stations on the basis of the terminal belonging information and the terminal locating information stored in the first and second storage means when the mobile communication terminal requests a start of a communication using a particular accounting system; communication means for sending information representing that the communication using the particular accounting system is possible to the mobile communication terminal on the sending side when the mobile communication terminals on the sending and receiving sides are assigned to the respective specified base stations; and transmit means for sending particular account applying information representing that the particular accounting system is applied to a communication cost of the communication using the particular accounting system to the accounting device when any mobile communication terminal carries out the communication using the particular accounting system, the control server applying the particular accounting system to the communication from any mobile communication terminal assigned to the specified base station included in the group to another mobile communication terminal assigned to the specified base station included in the group.

In the second embodiment of the present invention described above, it is preferable that the particular account applying information is information representing either exemption or reduction of the cost for the communication carried out by the mobile communication terminal. In this way, an increase of users of the mobile communication system according to this embodiment and an increase of customer gathering force to places base stations are installed can be performed.

Further, in the second embodiment of the present invention described above, it is much preferable that a control server further comprising: second obtaining means for obtaining a user identification specifying a user of the mobile communication terminal from the mobile communication terminal requesting the communication using the particular accounting system; register means for storing user information representing that which of the base station included in the group is usable for each user as the specified base station; and second determining means for determining whether or not the particular accounting system is applied to the communication of the mobile communication terminal requesting the communication using the particular accounting system on the basis of the user identification obtained from the mobile communication terminal.

In any construction of the second embodiment of the present invention described above, it is preferable that a control server still further comprising: delivery means for delivering the terminal locating information related to any mobile communication terminal to another mobile communication terminal requesting the delivery of the terminal locating information. By obtaining the information showing that another mobile communication terminal locates within the area of which base station by the mobile communication terminal, the user can know before the communication start that the communication using the particular accounting system can be possible for which mobile communication terminals.

In accordance with a third aspect of the present invention, there is provided a mobile communication method using a mobile communication system comprising a mobile communication network including a plurality of base stations; mobile communication terminals assigned to any of the base stations, which carrying out communications via the mobile communication network; an accounting device for accounting communication costs to the communications of the mobile communication terminals; and a control server for connecting to all the base stations included in a group including at least one base station and to the accounting device, and storing terminal belonging information representing that any of the base stations included in the group is the specified base station for the respective mobile communication terminals and terminal locating information representing the base station that the respective mobile communication terminals are now assigned to, comprising the steps of: sending information showing the base station that its own terminal is assigned to the control server by the mobile communication terminal; renewing the terminal locating information on the basis of the information obtained from the mobile communication terminal to register a position of the mobile communication terminal; requesting a communication with another mobile communication terminal using a particular accounting system from the control server by the mobile communication terminal; determining whether or not the mobile communication terminals on sending and receiving sides are assigned to the respective base stations on the basis of the terminal belonging information and the terminal locating information by the control server that the mobile communication terminal requests a start of the communication using the particular accounting system; sending a message representing that the communication using the particular accounting system is possible to the mobile communication terminal on the sending side from the control server when the mobile communication terminals on the sending and receiving sides are assigned to the respective specified base stations; establishing the communication with the mobile communication terminal on the receiving side by the mobile communication terminal having received the message from the control server; and sending particular account applying information representing that the particular accounting system is applied to a communication cost of the communication carried out by the mobile communication terminal using the particular accounting system to the accounting device from the control server, thereby applying the particular accounting system to the communication from any mobile communication terminal assigned to the specified base station included in the group to another mobile communication terminal assigned to the specified base station included in the group.

In the third embodiment of the present invention described above, it is preferable that the particular account applying information is information representing either exemption or reduction of the cost for the communication carried out by the mobile communication terminal. In this way, an increase of users of the mobile communication system according to this embodiment and an increase of customer gathering force to places base stations are installed can be performed.

In the third embodiment of the present invention described above, it is preferable that a mobile communication method further comprising the following steps inserted before the determining step described above: obtaining a user identification specifying a user of the mobile communication terminal from the mobile communication terminal requesting the communication using the particular accounting system by the control server; and determining whether or not the particular accounting system is applied to the communication of the mobile communication terminal requesting the communication using the particular accounting system on the basis of user information representing that which of the base station included in the group is usable for each user as the specified base station and the user identification obtained from the mobile communication terminal, which are pre-stored in the control server.

In the third embodiment of the present invention described above, it is preferable that a mobile communication method still further comprising the following step inserted after the registering step described above: delivering the terminal locating information related to any mobile communication terminal to another mobile communication terminal requesting the delivery of the terminal locating information. By obtaining the information showing that another mobile communication terminal locates within the area of which base station by the mobile communication terminal, the user can know before the communication start that the communication using the particular accounting system can be possible for which mobile communication terminals.

According to the present invention, the user of the mobile communication terminal can continuously use the communication in the specified area that the particular accounting system is applied and in the other areas that the normal accounting system is applied.

In the case that the user of the mobile communication terminal is a juridical person (a corporate person), by mounting a base station so that an office building becomes a specified area, no communication cost or reduction of the communication cost can be realized within the office building and the mobile communication terminals can be used in the same sense as extension telephones. On the other hand, outside the office building, the mobile communication terminals can be used as usual telephones.

When a store chain such as convenience stores and fast-food restaurants contracts with a communication carrier to mount a base station in each branch, the communications using the particular accounting system can be carried out within the specified areas and hence the services for applying the particular accounting system to the communications between the mobile communication terminals of the customers visited to the chain stores can be provided for the consumers. As a result, the owner of such chain stores can raise the customer gathering force by providing such services.

On the carrier side, the communication services can be provided to the areas conventionally unused such as the extensions of the company or the chain store branches and thus a new market can be opened up.

Furthermore, when the mobile communication system according to the present invention is constructed, there is no need for the carrier to add a large-scale improvement to the main facilities such as the existing switched mobile network and the accounting system. That is, the construction can be implemented by only adding the control server, the base stations and the applications in the mobile communication terminals to the existing facilities. Further, in this case, the equipment to be mounted is only the base station and hence the inventing cost can be largely reduced.

According to the present invention, the conventional infrastructure can be utilized by using a new add-on device onto the existing switched mobile network without its large improvement and hence a mobile communication system, a control server and a mobile communication method, wherein a particular communication cost separate from a normal communication cost can be set to communications between the mobile terminals locating in a specified area can be provided.

### BRIEF DESCRIPTION OF THE DRAWINGS

The objects, features and advantages of the present invention will become more apparent from the consideration of the following detailed description, taken in conjunction with the accompanying drawings, in which:

FIG. 1 is a schematic block diagram of a mobile communication system according to a first embodiment of the present invention;

FIG. 2 is a schematic block diagram of one embodiment of a mobile phone terminal used in the mobile communication system shown in FIG. 1;

FIG. 3 is a schematic view showing information stored in a nonvolatile random-access memory (NVRAM) of the mobile phone terminal shown in FIG. 2;

FIG. 4 is a schematic block diagram of one embodiment of a control server used in the mobile communication system shown in FIG. 1;

FIG. 5 is a schematic view showing information stored in the terminal (mobile phone terminal) information storage of the control server shown in FIG. 4;

FIG. 6 is a flow chart showing an operation at a communication start of the mobile communication system shown in FIG. 1;

FIG. 7 is a flow chart showing an operation when the communication is executed of the mobile communication system shown in FIG. 1;

FIG. 8 is a schematic view showing information of a communication history of each mobile phone terminal, which is recorded in a communication history recorder in the control server shown in FIG. 1;

FIG. 9 is a flow chart showing an operation at a communication end of the mobile communication system shown in FIG. 1;

FIG. 10 is a schematic view showing information of the communication history of each mobile phone terminal, which is recorded in a mobile services switching center (MSC) of a switched mobile network shown in FIG. 1;

FIG. 11 is a schematic diagram showing one embodiment of an operation sequence of a communication between the mobile phone terminals of the mobile communication system shown in FIG. 1;

FIG. 12 is a schematic view showing information stored in a terminal information storage of a control server of a mobile communication system according to a second embodiment of the present invention;

FIG. 13 is a flow chart showing an operation at a communication start of the mobile communication system according to the second embodiment of the present invention;

FIG. 14 is a schematic diagram showing one embodiment of an operation sequence between the mobile phone terminals of the mobile communication system according to the second embodiment of the present invention;

FIG. 15 is a schematic block diagram of one embodiment of a mobile communication system according to a third embodiment of the present invention;

FIG. 16 is a flow chart showing an operation at a communication start of the mobile communication system shown in FIG. 15;

FIG. 17 is a schematic diagram showing one embodiment of an operation sequence of the mobile phone terminals of the mobile communication system shown in FIG. 15;

FIG. 18 is a schematic block diagram of one embodiment of a mobile phone terminal used in a mobile communication system according to a fourth preferable embodiment of the present invention;

FIG. 19 is a schematic view showing information stored in a presence information storage of the mobile phone terminal shown in FIG. 18;

FIG. 20 is a schematic block diagram of one embodiment of a control server used in the mobile communication system according to the fourth embodiment of the present invention; and

FIG. 21 is a schematic view showing information stored in a presence information controller of the control server shown in FIG. 20.

### DESCRIPTION OF THE PREFERRED EMBODIMENTS

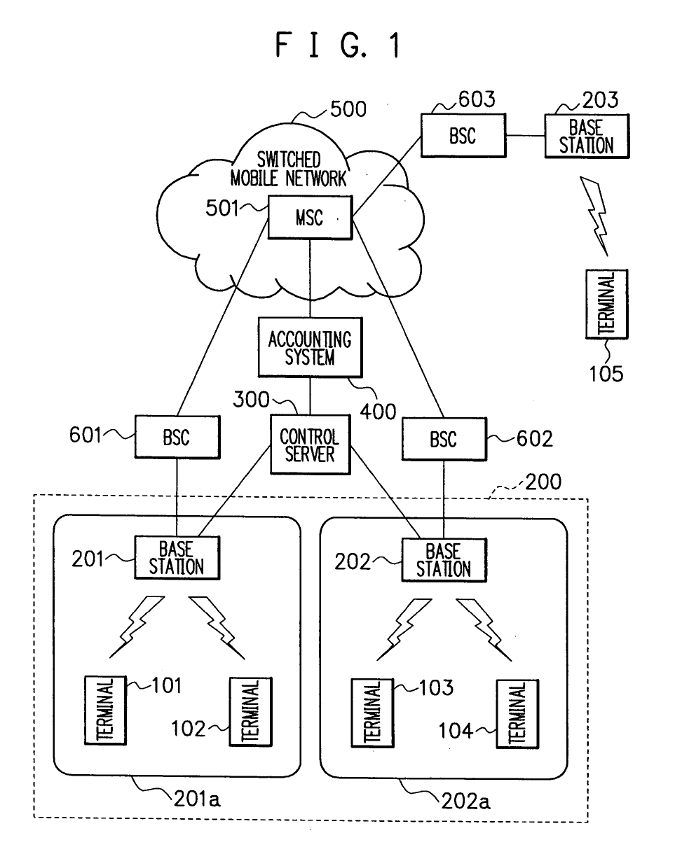

Referring now to the drawings, the present invention by embodiments will be described. There is a mobile communication system according to a first embodiment of the present invention as shown in FIG. 1. The mobile communication system comprises a group 200 including at least one area (for example, one area selected from area 201a and 202a, or, two or more areas may include), a control server 300, a base station 203, an accounting system 400, a switched mobile network 500 having an MSC (Mobile Services Switching Center) 501 and BSCs (Base Station Controllers) 601, 602 and 603. In this embodiment, the base station 203, the accounting system 400, the switched mobile network 500 and the BSCs 601 to 603 are already-existing facilities. The base station 203 is connected to the MSC 501 of the switched mobile network 500 via the BSC 603.

The area 201a includes mobile phone terminals 101 and 102 and a base station 201 connected to the MSC 501 of the switched mobile network 500 via the BSC 601. Similarly, the area 202a includes mobile phone terminals 103 and 104 and a base station 202 coupled to the MSC 501 of the switched mobile network 500 via the BSC 602. As shown in FIG. 1, the base station 201 produces the area 201a and within the area 201a, the mobile phone terminals 101 and 102 can receive radio waves emitted from the base station 201. That is, the mobile phone terminals 101 and 102 are assigned to the base station 201 within the area 201a by radio communications. In the same manner, the mobile phone terminals 103 and 104 are assigned to the base station 202 within the area 202a by the radio communications. Any mobile phone terminal can move in any area made up by its base station and can be assigned to the base station. The base station used for the present invention is preferable to have a produced area of approximately 100 m radius (so-called “a pico cell”). The base station having a smaller area than above is much preferable.

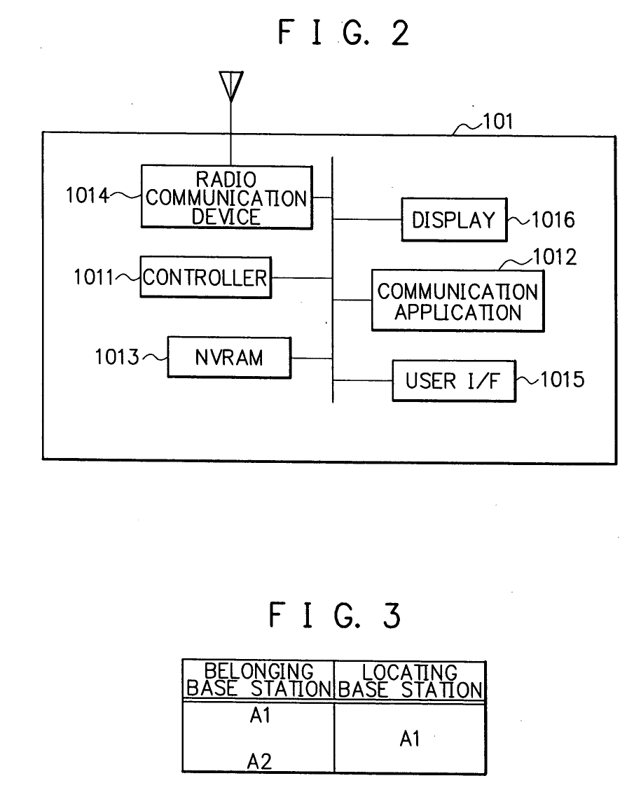

In FIG. 2, there is shown one embodiment of the mobile phone terminal 101 used in the mobile communication system shown in FIG. 1. The mobile phone terminal 101 includes a controller 1011, a communication application part 1012, an NVRAM (nonvolatile random-access memory) 1013, a radio communication device 1014, a user I/F (interface) 1015 and a display 1016. The other mobile phone terminals 102 to 105 have the same construction as the mobile phone terminal 101. In other words, a mobile phone terminal 10X (X=one integer of 2 to 5) includes a controller 10X1, a communication application part 10X2, an NVRAM 10X3, a radio communication device 10X4, a user I/F 10X5 and a display 10X6.

The controller (CPU) 1011 controls the operations of the other members of the mobile phone terminal 101. The communication application part 1012 stores an application program(s) on the basis of an application platform such as Java (R) or BREW (R) and processes about the communication and the communication application part 1012 is non-volatile or volatile storage for storing the application(s) or program(s). The controller 1011 executes to communicate by using program(s) stored in the communication application part 1012. The NVRAM 1013 stores base station IDs of the base stations that its own terminal belongs to and a base station ID of the base station that its own terminal now locates in, as shown in FIG. 3. The radio communication device 1014 is a function unit that the mobile phone terminal 101 communicates with the base station and processes information or signal conversions, for instance, encodes the information to be transmitted into radio signals and decodes the radio signals received into the information. The user I/F 1015 is a function unit that a user inputs commands to the mobile phone terminal 101 and includes number keys, letter keys, a pointing device, a touch panel and the like. The display 1016 is a function unit for presenting the information to the user and includes a visually displaying device such as an LCD, a speaker, a vibrator and so on.

In this embodiment, the “belong” means that one mobile phone terminal registers an area produced by a base station as the area where a particular accounting system is applied to the communication. Hence, for example, when the mobile phone terminal 101 registers the area 201a produced by the base station 201, the area 201a can be represented as a specified area of the mobile phone terminal 101.

Further, the “locate” means that when a mobile phone terminal is present within an area (cell) produced by a base station, the mobile phone terminal is “assigned” to the base station.

Hence, when one mobile phone terminal “locates” within a specified area, a user can carry out the communication that the particular accounting system is applied to.

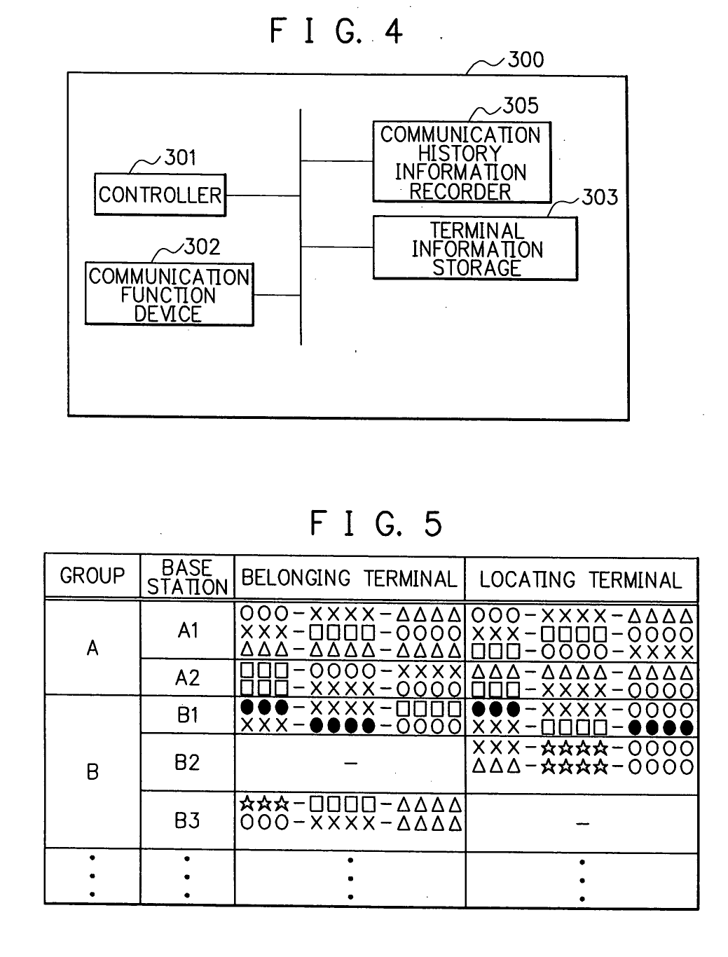

In FIG. 4, there is shown one embodiment of the control server 300 shown in FIG. 1. The control server 300 includes a controller 301, a communication function device 302, a terminal information storage 303 and a communication history information recorder 305. The controller 301 controls the other members of the control server 300. The communication function device 302 is a function unit for sending and receiving information to and from the base stations 201 and 202 and the accounting system 400 and processes information conversions, for example, encodes the information to be sent and decodes the information received. The terminal information storage 303 stores terminal IDs that mobile phone terminals belong to and terminal IDs that the mobile phone terminals locate in per every base station in each group, as shown in FIG. 5. The communication history information recorder 305 records the information of the communication history such as the mobile phone terminals that the communications are carried out by using the base stations, the base stations used by the mobile phone terminals and the communication time when the base stations are used by the mobile phone terminals.

The control server 300 is connected to the base stations 201 and 202 producing the respective areas 201a and 202a and to the accounting system 400.

The accounting system 400, the MSC 501 and the BSCs 601 to 603 can use conventional ones having the same constructions as those of a conventional mobile communication system, and thus the detailed descriptions thereof can be omitted for brevity.

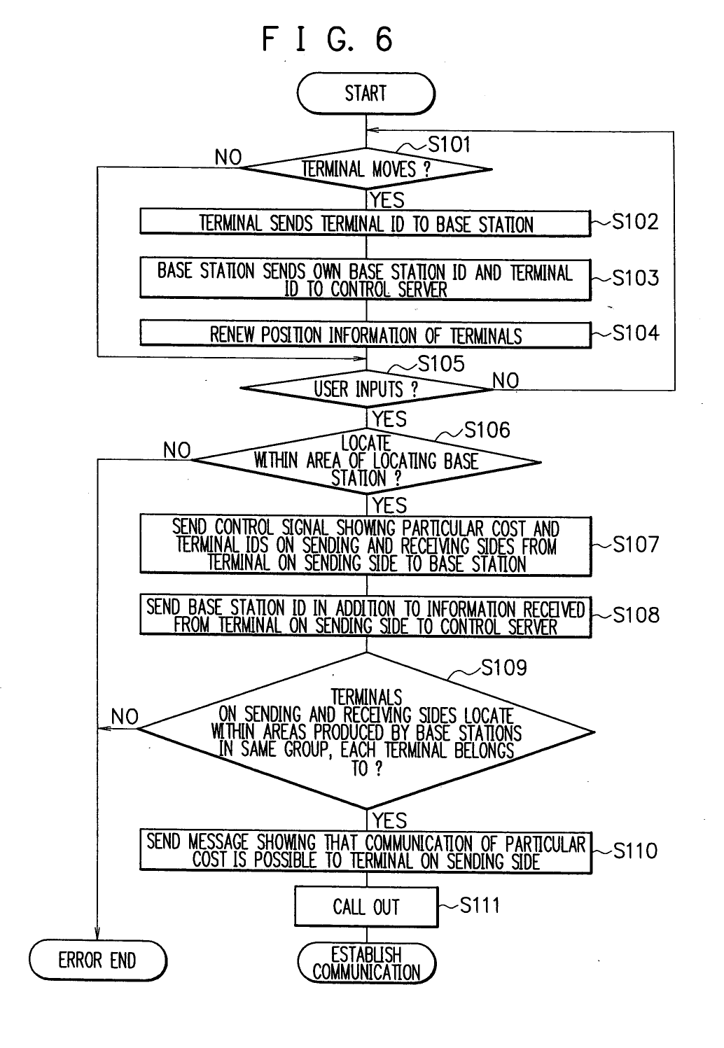

Now, an operation of the mobile communication system described above will be described in detail in connection with FIG. 6 to FIG. 11.

In this case, in the control server 300, in order to apply the particular accounting system to the specified mobile phone terminals, the terminal information storage 303 prestores the terminal IDs of the mobile phone terminals and the base station IDs of the base stations as the group of a plurality of the mobile phone terminals that the particular accounting system is applied to and at least one base station that these mobile phone terminals belong to. The NVRAMs 1013 to 1043 of the mobile phone terminals 101 to 104 store the station IDs of the base stations, respectively, that the respective mobile phone terminals belong to.

Now, suppose that the mobile phone terminal 101 is on the sending side and the mobile phone terminal 102 is on the receiving side. Assume that the mobile phone terminal 101 belongs to the base stations 201 and 202 and the mobile phone terminal 102 belongs to the base station 202 only. Further, suppose that the mobile phone terminal 101 locates within the area 201a produced by the base station 201 in the initial state and the mobile phone terminal 102 locates within the area 202a produced by the base station 202.

In FIG. 6, there is shown a flow chart of an operation of the mobile communication system at its start of a communication that the particular accounting system is applied to.

When the mobile phone terminal 101 is moved from the prelocated area 201a to the area 202a produced by the base station 202 in step S101/Yes, the controller 1011 by using the application (program) in the communication application 1012 of the mobile phone terminal 101 detects this change, that is, its own terminal moves to another area, and sends a control signal to the base station 202 in step S102.

When receiving the control signal from the mobile phone terminal 101, the base station 202 sends the terminal ID of the mobile phone terminal 101, i.e., the sending source of the control signal and its own base station ID to the control server 300 in step S103.

In the control server 300, when receiving the terminal ID and the base station ID from the base station 202, the controller 301 renews the information of the terminal information storage 303 on the basis of the received information so that the mobile phone terminal 101 locates in the base station 202 in step S104.

When an operation for carrying out a communication using a particular accounting system, for example, an extension communication of no communication cost is input to the user I/F 1015 of the mobile phone terminal 101 in step S105/Yes, by executing the application(s) or program(s) stored in the communication application 1012, the controller 1011 detects this operation and determines whether or not its own terminal 101 locates within the specified area, that is, the area 201a or 202a produced by the base station 201 or 202 the mobile phone terminal belongs to in step S106.

When determining that its own terminal locates within the specified area in step S106/Yes, the controller 1011 using the application in the communication application 1012 executes to send a control signal or an extension identifying information for showing the communication using the particular accounting system to the base station 202 by using the radio communication device 1014 in step S107. On this occasion, by using the application of the communication application part 1012, the controller 1011 executes to send the terminal ID of the mobile phone terminal 102 which receives the terminal ID of the mobile phone terminal 101 and the communication, to the base station 202 in step S107.

When receiving the control signal representing the communication using the particular accounting system and the terminal ID of the mobile phone terminal 102 on the receiving side from the mobile phone terminal 101 on the sending side, the base station 202 sends its own base station ID in addition to the information representing the communication using the particular accounting system and the terminal IDs of the mobile phone terminals 101 and 102 to the control server 300 in step S108.

In the control server 300, when receiving the information showing the communication using the particular accounting system and the terminal IDs of the mobile phone terminals 101 and 102 on the sending and receiving sides, the controller 301 determines whether or not the mobile phone terminal 101 on the sending side and the mobile phone terminal 102 on the receiving side belong to the respective base stations in the same group and the mobile phone terminals 101 and 102 locate within the respective specified areas in step S109.

When the controller 301 of the control server 300 determines that the mobile phone terminals 101 and 102 on the sending and receiving sides belong to the respective base stations in the same group and the mobile phone terminals locate within the respective specified areas, that is, the mobile phone terminal 101 locates within the area 201a or 202a and the mobile phone terminal 102 locates within the area 202a in step S109/Yes, the controller sends a message that the communication using the particular accounting system is possible to the mobile phone terminal 101 on the sending side by using the communication function device 302 in step S110.

In the mobile phone terminal 101, when receiving the message that the communication using the particular accounting system is possible, the controller 1011 executes the application(s) or program(s) stored in the communication application 1012 for calling out in the same manner as a usual communication in step S111. Thereafter, the controller 1011 by using the application(s) or program(s) stored in the communication application part 1012 establishes the connection between the mobile phone terminals on the sending the receiving sides in the same procedure as a communication of a normal accounting system and keeps the connection.

When the mobile phone terminal 101 on the sending side does not locate within the specified area, that is, the area 201a or 202a in step S106/No or the mobile phone terminal 102 does not locate within the specified area, that is, the area 202a, in step S109/No, the process is finished. In this case, the controller 1102 by using the application(s) or program(s) stored in the communication application part 1012 executes to display a message that the communication using the particular accounting system is impossible on the display 1016 of the mobile phone terminal 101.

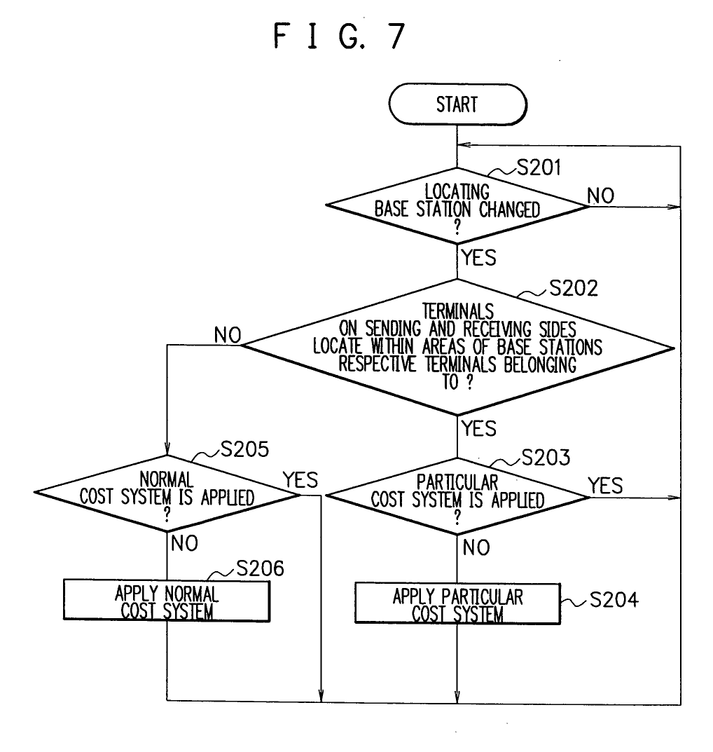

An operation of the mobile communication system after the communication start, in which the particular accounting system is applied in the procedure described above, will now be described in detail with reference to FIG. 7.

In FIG. 7, there is shown a flow chart showing an operation of the communication between the mobile phone terminals after the communication start under the condition that the particular accounting system is applied to the mobile phone terminals.

In the control server 300, the controller 301 determines on the basis of the information stored in the terminal information storage 303 whether or not at least one of the mobile phone terminals 101 and 102 on the sending and receiving sides moves to another area in step S201. When the controller 301 determines that none of the mobile phone terminals 101 and 102 moves to another area in step S201/No, the controller 301 determines again after a predetermined time passes whether or not at least one of the mobile phone terminals 101 and 102 on the sending and receiving sides moves to another area in step S201.

When the controller 301 determines that at least one of the mobile phone terminals 101 and 102 has moved to another area in step S201/Yes, the controller 301 determines whether or not the target area of the moved mobile phone terminal belongs to the same group and the target area is the specified area of the moved mobile phone terminal in step S202.

When after the moving, the locating areas of the mobile phone terminals 101 and 102 belong to the same group and are the specified areas of the mobile phone terminals 101 and 102 in step S202/Yes, the controller determines whether or not the particular accounting system is applied to the established communication between the mobile phone terminals 101 and 102 in step S203. When the particular accounting system is not applied to the established communication between the mobile phone terminals 101 and 102 in step S203/No, the particular accounting system is applied to the established communication in step S204. When the particular accounting system is applied to the established communication between the mobile phone terminals 101 and 102 in step S204/Yes, the established communication is maintained.

Back to step S202, when the target areas of the moved mobile phone terminals 101 and 102 are not the areas produced by the base stations belonging to the same group or not the specified areas of the mobile phone terminals 101 and 102 even if the target areas belong to the same group in step S202/No, the controller 301 determines whether or not a normal accounting system is applied to the established communication between the mobile phone terminals 101 and 102 in step S205. When the normal accounting system is not applied to the established communication between the mobile phone terminals 101 and 102 in step S205/No, the normal accounting system is applied to the established communication in step S206.

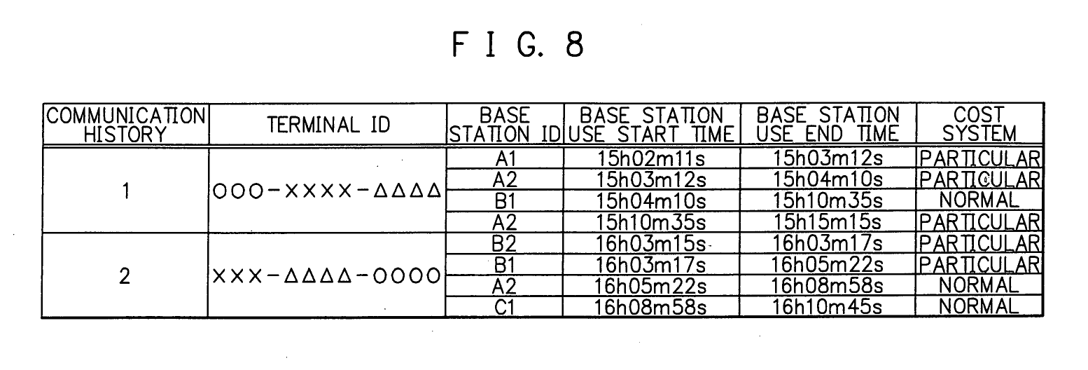

As described above, even when at least one of the mobile phone terminals 101 and 102 on the sending and receiving sides moves out of the specified areas during the communication, the communication can be continuously kept by the operation of the control server 300. Hence, the information of the communication history such as the mobile phone terminals that the communications are carried out by using the base stations, the base stations used by the mobile phone terminals and the communication time when the base stations are used by the mobile phone terminals can be stored in the communication history recorder 305, as shown in FIG. 8.

In this embodiment, when any of the mobile phone terminals on the sending and receiving sides is moved out of the specified areas, although the communication between the mobile phone terminals is continuously kept by applying the normal accounting system in the above-description, the communication can be cut off.

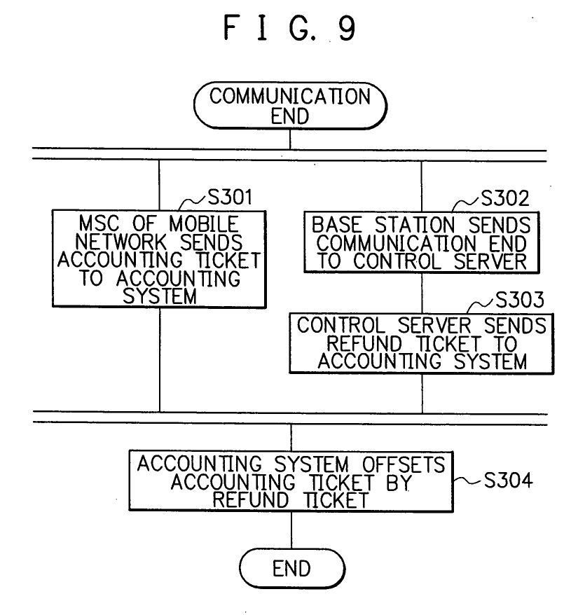

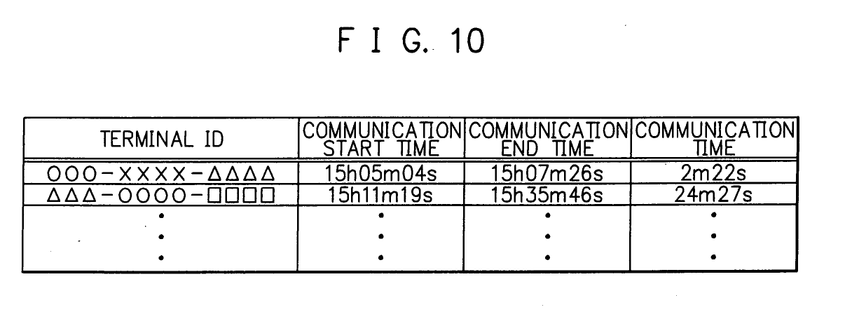

An operation of the mobile communication system at an end of the communication that the particular accounting system is applied to will be described in detail in connection with FIG. 9 and FIG. 10.

In FIG. 9, there is shown a flow chart showing an operation of the mobile communication system at its communication end when the communication using the particular accounting system is to be cut off. In this embodiment, suppose that the mobile phone terminal 101 on the sending side locates within the area 202a produced by the base station 202 at the communication end.

In the switched mobile network 500, the MSC 501 stores the communication history such as the mobile phone terminals and their communication time, as shown in FIG. 10. When the communication is finished, the MSC 501 outputs information such as an accounting ticket for accounting a communication cost depending on the communication time of the mobile phone terminal 101 to the accounting system 400 in step S301. On the other hand, at the same time, the base station 202 that the mobile phone terminal 101 belongs to at the communication end sends the communication end to the control server 300 in step S302. In the control server 300, when receiving the communication end from the base station 202, the controller 301 outputs information such as a refunding ticket for refunding a communication cost depending on the communication time of the mobile phone terminal 101 on the basis of the information of the communication history stored in the communication history recorder 305 to the accounting system 400 in step S303.

When receiving the information such as the accounting ticket from the MSC 501 and the information such as the refunding ticket from the controller 301 of the control server 300, the accounting system 400 offsets the accounting ticket by the refunding ticket in step S304. As a result, the particular accounting system, that is, the reduction or the exemption of the cost for the communications between the mobile phone terminals locating within the specified area can be attained.

In this case, when at least one of the mobile phone terminals on the sending and receiving sides once moves out of the specified area during the communication, the control server 300 sends a refunding ticket depending on the time that the particular accounting system is applied to the accounting system 400.

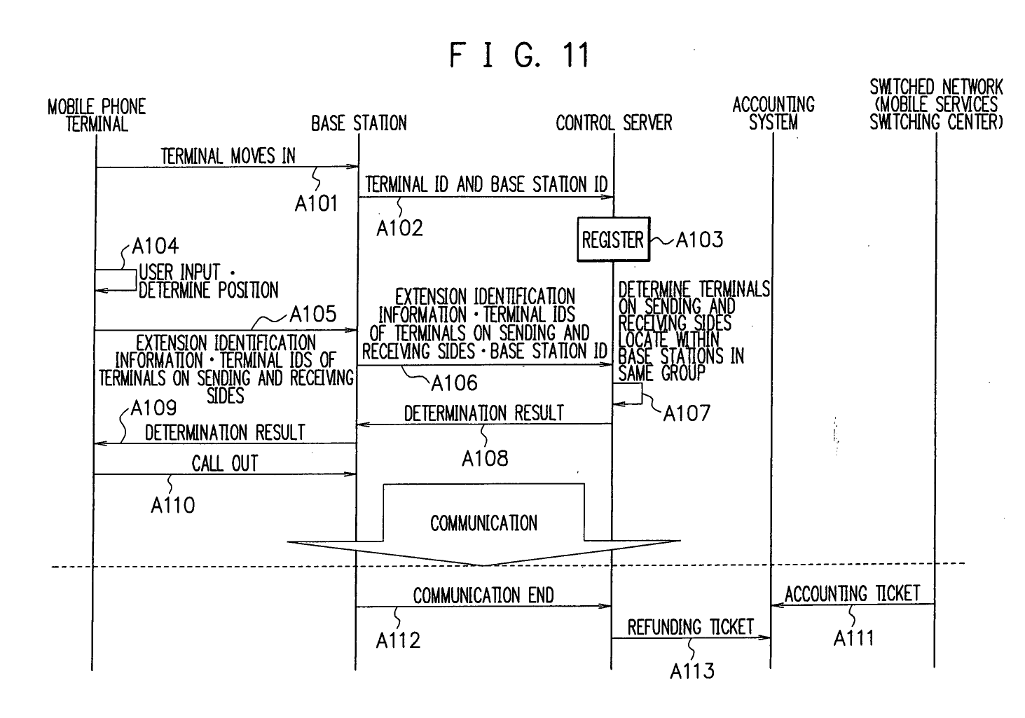

In FIG. 11, there is shown one embodiment of an operation sequence when a communication from the mobile phone terminal 101 to the mobile phone terminal 102 is carried out under the condition that the particular accounting system is applied.

When the mobile phone terminal 101 moves into the specified area such as the area 201a or 202a, the controller 1011 using the application in the communication application part 1012 executes to send the information representing that the mobile phone terminal 101 moves within the area 201a or 202a to the base station 201 or 202 by using the radio communication device 1014 (A101). When receiving this information, the base station 201 or 202 sends the terminal ID of the mobile phone terminal 101 and its own base station ID to the control server 300 (A102). The control server 300 then renews the information stored in the terminal information storage 303 by using the information received from the base station 201 or 202 (A103).

When the operation for carrying out the communication that the particular accounting system is applied to is input to the user I/F 1015 of the mobile phone terminal 101, the controller 1011 using the application in the communication application part 1012 executes to check the information stored in the NVRAM 1013 to determine that its own terminal locates within the specified area such as the area 201a or 202a (A104). When determining that its own terminal locates within the specified area, the controller 1011 using the application in the communication application 1012 executes to send the control signal showing the communication using the particular accounting system, the terminal ID of the mobile phone terminal 102 on the receiving side and its own terminal ID to the base station 201 or 202 (A105). The base station 201 or 202 sends its own base station ID besides the information received from the mobile phone terminal 101 to the control server 300 (A106).

In the control server 300, when receiving the information representing the communication using the particular accounting system from the base station 201 or 202, the controller 301 looks up the information stored in the terminal information storage 303 and determines that the mobile phone terminals 101 and 102 locate within the respective specified areas (A107). Thereafter, the controller 301 sends the information representing that the communication using the particular accounting system is possible to the base station 201 or 202 by using the communication function device 302 (A108). The base station 201 or 202 transfers the information sent from the controller 301 of the control server 300 to the mobile phone terminal 101 using the control signal (A109).

In the mobile phone terminal 101, when receiving the information representing that the communication using the particular accounting system is possible from the base station 201 or 202, the controller 1011 using the application in the communication application part 1012 executes to establish the communication in the same manner as the normal communication (A110).

In the switched mobile network 500, when the communication is finished, the MSC 501 sends the information such as the accounting ticket for accounting the communication cost depending on the communication time of the mobile phone terminal 101 to the accounting system 400 (A111). On the other hand, the base station 201 or 202 sends the information of the communication end to the control server 300 (A112). In the control server 300, when receiving the information of the communication end, the controller 301 sends the information such as the refunding ticket for refunding the communication cost of the mobile phone terminal 101 to the accounting system 400 (A113).

The accounting system 400 offsets the charging cost of the accounting ticket by the refunding cost of the refunding ticket to achieve the reduction or the exemption of the cost of the communication called out from the mobile phone terminal 101.

In the mobile communication system according to the preferred embodiment of the present invention, as described above, when the user having the mobile phone terminal on the sending side locates within the specified area and the mobile phone terminal on the receiving side locates within the specified area, the user can carry out the communication using the particular accounting system.

In this mobile communication system, the control server operates separate from the MSC of the switched mobile network provided by the carrier and hence the control server can be operated by another carrier. That is, an application service provider (ASP) can carry out controls of users and terminals, which services are provided for, and operations of a control server, that is, services such as controls of position information of mobile phone terminals and refunds of communication costs.

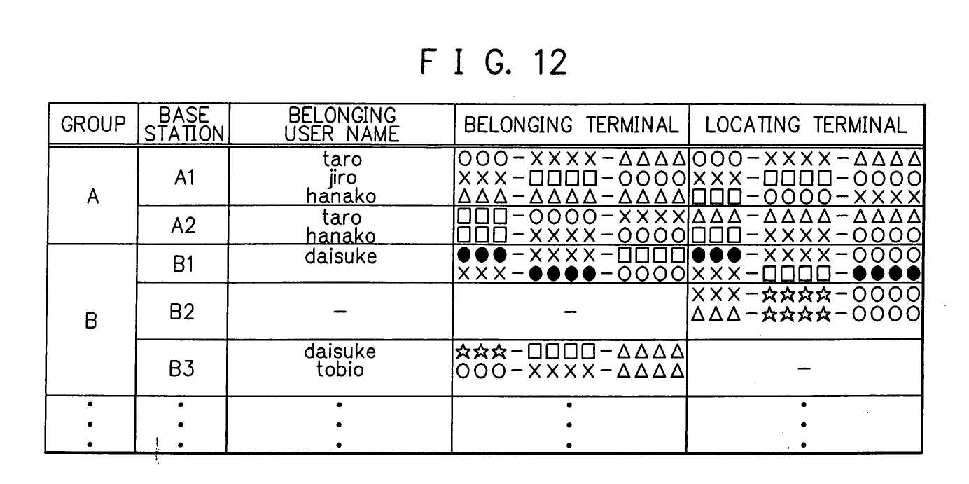

A mobile communication system according to a second preferable embodiment of the present invention will now be described in detail with reference to FIG. 12 to FIG. 14. In this embodiment, the mobile communication system has the same construction as that of the first embodiment described above and the detailed description thereof can be omitted for brevity.

In FIG. 12, there is shown one embodiment of information stored in a terminal information storage 303 of a control server 300 used for the mobile communication system. In this embodiment, a user ID including information specifying a user of a mobile phone terminal, a user name, a password, biometrics information and the like is set to the user of the mobile phone terminal, and the control server 300 stores the information of the user ID besides a terminal ID of the mobile phone terminal belonging to each base station in its terminal information storage 303. In other words, in this embodiment, the base station is previously set to both the user and the mobile phone terminal, which belong to the base station.

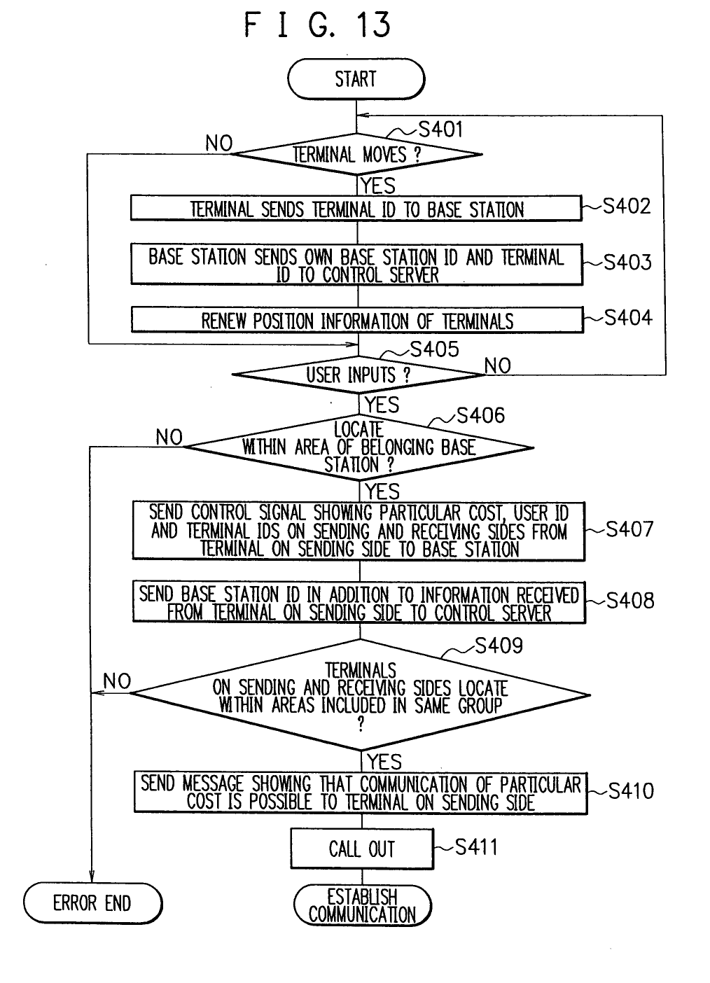

In FIG. 13, there is shown a flow chart showing an operation of the mobile communication system according to the second embodiment of the present invention. In the same manner as the first embodiment described above, when a mobile phone terminal 101 on a sending side moves from an area of one base station to another area of another base station in step S401/Yes, the mobile phone terminal 101 sends its own terminal ID to the target base station in step S402. When receiving the terminal ID from the mobile phone terminal 101, the base station sends its own base station ID and the terminal ID received from the mobile phone terminal 101 to the control server 300 in step S403. In the control server 300, when receiving such information, a controller 301 renews the information stored in the terminal information storage 303 in step S404.

When the user of the mobile phone terminal 101 inputs his own user ID to a user I/F 1015 of the mobile phone terminal 101 in order to start a communication using a particular accounting system in step S405, a controller 1011 using the application in a communication application part 1012 executes to look up information of an NVRAM 1013 and determines whether or not its own terminal locates within a specified area in step S406.

When the mobile phone terminal 101 on the sending side locates within the specified area such as an area 201a or 202a in step S406/Yes, the controller 1011 using the application in the communication application part 1012 executes to send a control signal such as extension identifying information for representing a communication using the particular accounting system, the user ID and the terminal IDs of its own terminal 101 and a mobile phone terminal 102 on a receiving side to a base station 201 or 202 in step S407. Now, suppose that the mobile phone terminal 101 locates within the area 201a and the mobile phone terminal 102 locates within the area 202a.

When receiving such information, the base station 201 sends its own base station ID in addition to the received information to the control server 300 in step S408.

In the control server 300, when receiving the information from the base station 201, the controller 301 looks up the information stored in the terminal information storage 303 and checks whether or not the same user ID as the user ID obtained from the mobile phone terminal 101 on the sending side is stored in the terminal information storage 303. When the user ID obtained from the mobile phone terminal 101 on the sending side is coincident with the information stored in the terminal information storage 303, the controller 301 determines whether or not the mobile phone terminals 101 and 102 on the sending and receiving sides locate within the respective specified areas on the basis of the information stored in the terminal information storage 303 in step S409.

When the mobile phone terminals 101 and 102 on the sending and receiving sides locate within the respective specified areas in step S409/Yes, the controller 301 of the control server 300 sends a message representing that a communication using the particular accounting system is possible to the mobile phone terminal 101 by using the communication function device 302 in step S410.

When receiving the message representing that the communication using thee particular accounting system is possible from the server 300, the mobile phone terminal 101 calls out in the same manner as a normal communication to establish the communication in step S411.

In this embodiment, after the communication establishment described above, the operation such as a switching of the accounting systems and a refunding of the communication costs of the mobile communication system is the same as that of the first embodiment and thus the description thereof can be omitted.

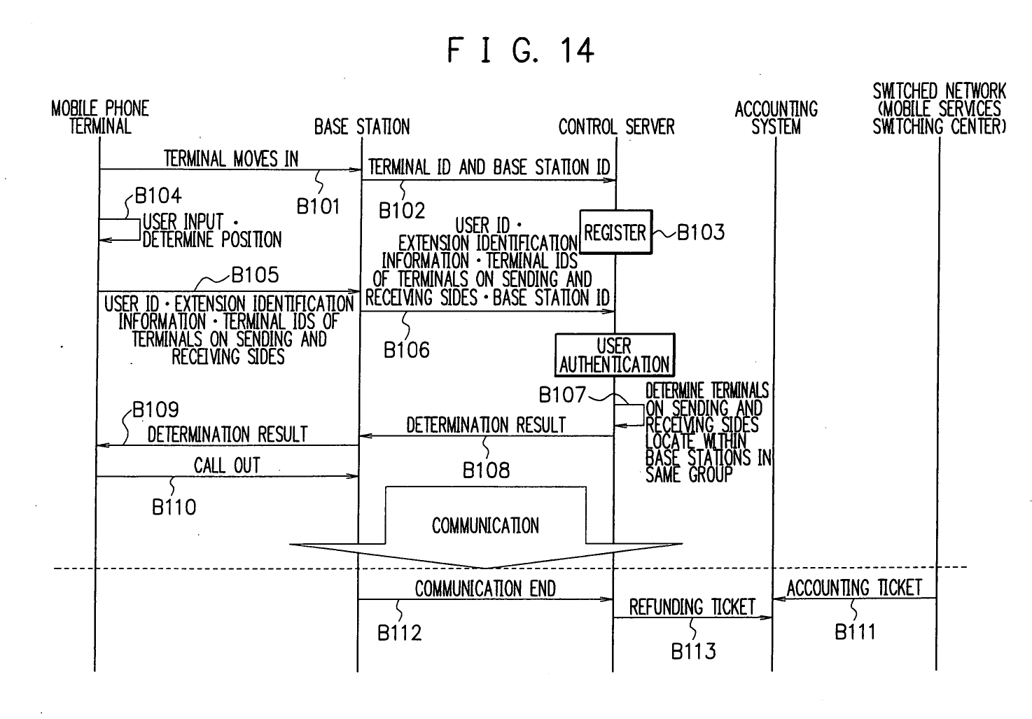

In FIG. 14, there is shown one embodiment of an operation sequence when the communication from the mobile phone terminal 101 to the mobile phone terminal 102 is carried out under the condition that the particular accounting system is applied.

When the mobile phone terminal 101 moves into the specified area such as the area 201a or 202a, the controller 1011 using the application in the communication application part 1012 executes to send the information representing that the mobile phone terminal 101 moves within the area 201a or 202a to the base station 201 or 202 by using the radio communication device 1014 (B101). When receiving this information, the base station 201 or 202 sends the terminal ID of the mobile phone terminal 101 and its own base station ID to the control server 300 (B102). The control server 300 then renews the information stored in the terminal information storage 303 by using the information received from the base station 201 or 202 (B103).

When the user of the mobile phone terminal 101 inputs his own user ID to a user I/F 1015 of the mobile phone terminal 101 in order to start a communication using the particular accounting system, the controller 1011 using the application in the communication application part 1012 executes to look up information of an NVRAM 1013 to determine that its own terminal locates within the specified area such as the area 201a or 202a (B104). When determining that its own terminal locates within the specified area, the controller 1011 using the application in the communication application part 1012 executes to send the control signal showing the communication using the particular accounting system, the terminal ID of the mobile phone terminal 102 on the receiving side, its own terminal ID and the user ID to the base station 201 or 202 (B105). The base station 201 or 202 sends its own base station ID besides the information received from the mobile phone terminal 101 to the control server 300 (B106).

In the control server 300, when receiving the information representing the communication using the particular accounting system from the base station 201 or 202, the controller 301 looks up the information stored in the terminal information storage 303 and checks whether or not the same user ID as the user ID obtained from the mobile phone terminal 101 on the sending side is stored in the terminal information storage 303. When the user ID obtained from the mobile phone terminal 101 on the sending side is coincident with the information stored in the terminal information storage 303, the controller 301 determines whether or not the mobile phone terminals 101 and 102 on the sending and receiving sides locate within the respective specified areas (B107). Thereafter, the controller 301 sends the information representing that the communication using the particular accounting system is possible to the base station 201 or 202 by using the communication function device 302 (B108). The base station 201 or 202 transfers the information sent from the controller 301 of the control server 300 to the mobile phone terminal 101 using the control signal (B109).

In the mobile phone terminal 101, when receiving the information representing that the communication using the particular accounting system is possible from the base station 201 or 202, the controller 1011 using the application in the communication application part 1012 executes to establish the communication in the same manner as the normal communication (B110).

In the switched mobile network 500, when the communication is finished, the MSC 501 sends the information such as the accounting ticket for accounting the communication cost depending on the communication time of the mobile phone terminal 101 to the accounting system 400 (B111). On the other hand, the base station 201 or 202 sends the information of the communication end to the control server 300 (B112). In the control server 300, when receiving the information of the communication end, the controller 301 sends the information such as the refunding ticket for refunding the communication cost of the mobile phone terminal 101 to the accounting system 400 (B113).

The accounting system 400 offsets the charging cost of the accounting ticket by the refunding cost of the refunding ticket to achieve the reduction or the exemption of the cost of the communication called out from the mobile phone terminal 101.

In this embodiment of the mobile communication system, although the mobile phone terminals locate within the respective specified areas, if the user does not register his user ID beforehand, the user cannot implement the communication using the particular accounting system. Hence, when another person uses the mobile phone terminal of the user, the communication using the particular accounting system cannot be conducted. As a result, the communication using the particular accounting system by another person can be effectively prevented.

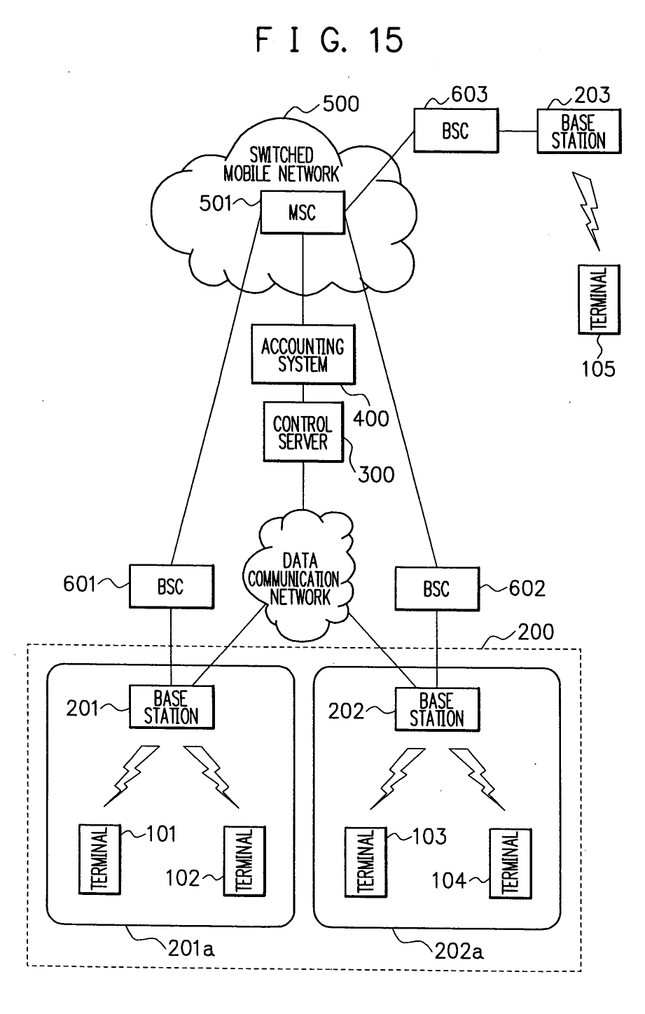

A mobile communication system according to a third preferable embodiment of the present invention will now be described in detail in connection with FIG. 15 to FIG. 17.

In FIG. 15, there is shown a mobile communication system according to the third embodiment of the present invention. In this embodiment, the mobile communication system has the same construction as that of the first embodiment, except that there is a data communication network between a control server 300 and base stations 201 and 202. Further, in this case, mobile phone terminals 101 to 105 provided with a data communication function and can carry out data communications with the control server 300 by using the base stations 201 and 202 as physical repeater stations for converting radio signals and electric signals. That is, a radio communication device 1014 of each mobile phone terminal and a communication function device 302 of the control server 300 have the data communication function.

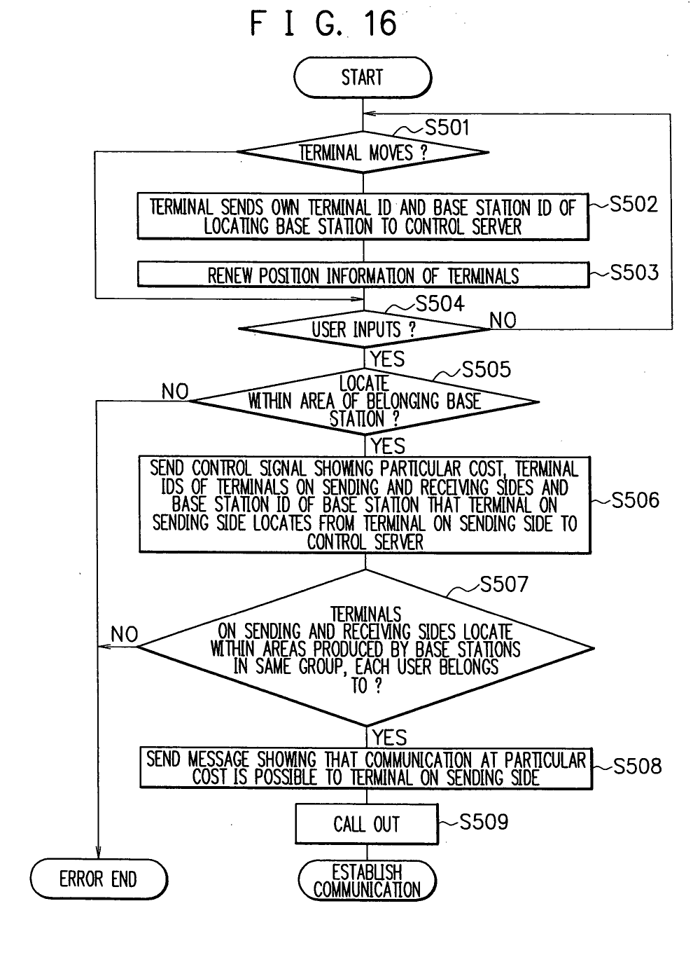

In FIG. 16, there is shown a flow chart showing an operation of the mobile communication system according to the third embodiment of the present invention. In the same manner as the first embodiment described above, when one of mobile phone terminals 101 to 105 moves from an area of one base station to another area of another base station in step S501/Yes, the mobile phone terminal sends its own terminal ID and a base station ID of the base station that the mobile phone terminal belongs to the control server 300 by using the data communication function of its radio communication device 1014 in step S502. When receiving such information from the mobile phone terminal, a controller 301 of the base station renews information stored in its terminal information storage 303 on the basis of the received information in step S503.

Now, suppose that the mobile phone terminal 101 is on a sending side and the mobile phone terminal 102 is on a receiving side. When a user of the mobile phone terminal 101 inputs information for starting a communication using a particular accounting system to a user I/F 1015 of the mobile phone terminal 101 in step S504, a controller 1011 using the application in a communication application part 1012 executes to determine whether or not its own terminal locates within a specified area in step S505.

When the mobile phone terminal 101 on the sending side locates within the specified area such as an area 201a or 202a in step S505/Yes, the controller 1011 using the application in the communication application 1012 executes to send data for representing a communication using the particular accounting system, the base station ID of the base station that its own terminal belongs to and the terminal IDs of its own terminal 101 and the mobile phone terminal 102 on the receiving side to the control server 300 by using the data communication function in step S506. Now, suppose that the mobile phone terminal 101 locates within the area 201a and the mobile phone terminal 102 locates within the area 202a.

In the control server 300, when receiving the information from the mobile phone terminal 101 on the sending side, the controller 301 looks up the information stored in the terminal information storage 303 and determines whether or not the mobile phone terminals 101 and 102 on the sending and receiving sides locate within the respective specified areas in step S507.

When the mobile phone terminals 101 and 102 on the sending and receiving sides locate within the respective specified areas in step S507/Yes, the controller 301 of the control server 300 sends a message representing that the communication using the particular accounting system is possible to the mobile phone terminal 101 on the sending side by using the data communication function of the communication function device 302 in step S508. When receiving this message from the server 300, the mobile phone terminal 101 on the sending side establishes the communication in the same manner as a normal communication in step S509.

In this embodiment, after the communication establishment described above, the operation such as a switching of the accounting systems and a refunding of the communication costs of the mobile communication system is the same as that of the first embodiment and thus the description thereof can be omitted.

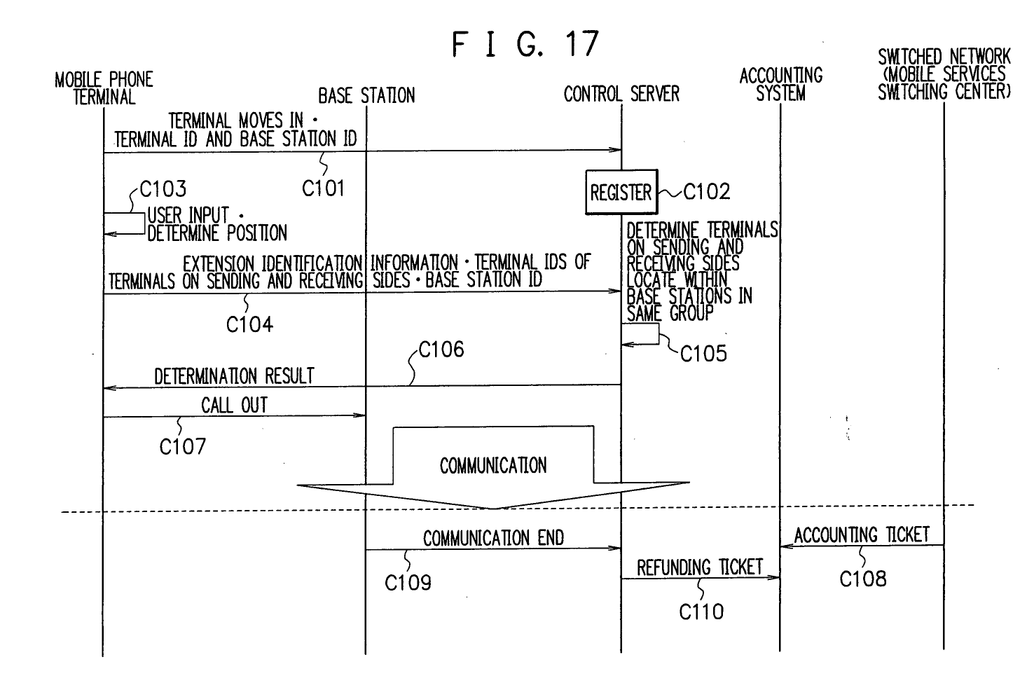

In FIG. 17, there is shown one embodiment of an operation sequence when the communication from the mobile phone terminal 101 to the mobile phone terminal 102 is carried out under the condition that the particular accounting system is applied.

When the mobile phone terminal 101 moves into the specified area such as the area 201a or 202a, the controller 1011 using the application in the communication application part 1012 executes to send the information representing that the mobile phone terminal 101 moves within the specified area to the control server 300 (C101). The control server 300 then renews the information stored in the terminal information storage 303 by using the information received from the mobile phone terminal 101 (C102).

When an operation for carrying out a communication using the particular accounting system is input to a user I/F 1015 of the mobile phone terminal 101, the controller 1011 using the application in the communication application part 1012 executes to look up information of an NVRAM 1013 and determines that its own terminal locates within the specified area such as the area 201a or 202a (C103). When determining that its own terminal locates within the specified area, the controller 1011 using the application in the communication application part 1012 executes to send information such as extension identifying information representing the communication using the particular accounting system, the terminal ID of the mobile phone terminal 102 on the receiving side, its own terminal ID and the base station ID of the base station that the mobile phone terminal 101 locates to the control server 300 by using the data communication function of the radio communication device 1014 (C104).

In the control server 300, when receiving the information representing the communication using the particular accounting system from the mobile phone terminal 101, the controller 301 looks up the information stored in the terminal information storage 303 and determines whether or not the mobile phone terminals 101 and 102 on the sending and receiving sides locate within the respective specified areas (C105). Thereafter, the controller 301 sends the information representing that the communication using the particular accounting system is possible to the mobile phone terminal 101 by using the data communication function of the communication function device 302 (C106).

In the mobile phone terminal 101, when receiving the information representing that the communication using the particular accounting system is possible from the control server 300, the controller 1011 using the application in the communication application part 1012 executes to establish the communication in the same manner as the normal communication (C107).

In the switched mobile network 500, when the communication is finished, the MSC 501 sends the information such as the accounting ticket for accounting the communication cost depending on the communication time of the mobile phone terminal 101 to the accounting system 400 (C108). On the other hand, the base station 201 or 202 sends the information of the communication end to the control server 300 (C109). In the control server 300, when receiving the information of the communication end, the controller 301 sends the information such as the refunding ticket for refunding the communication cost of the mobile phone terminal 101 to the accounting system 400 (C110).

The accounting system 400 offsets the charging cost of the accounting ticket by the refunding cost of the refunding ticket to achieve the reduction or the exemption of the cost of the communication called out from the mobile phone terminal 101.

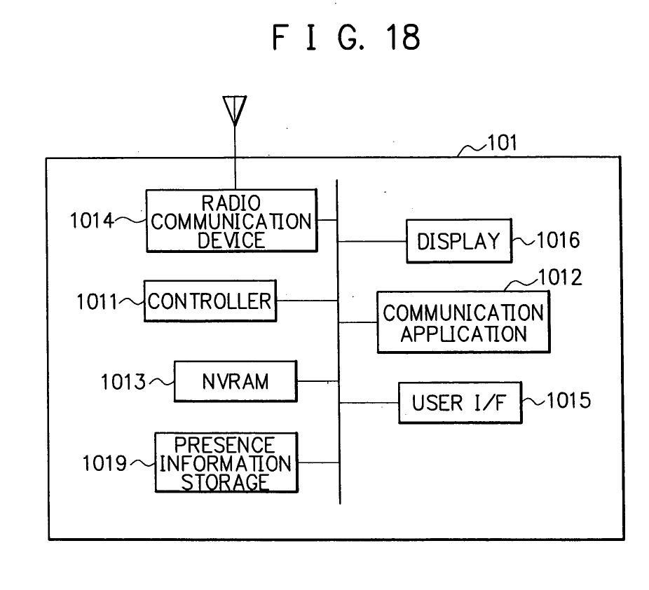

A mobile communication system according to a fourth preferable embodiment of the present invention will now be described in detail with reference to FIG. 18 to FIG. 21.

As shown in the above embodiments described above, in the mobile communication system of the present invention, in order to apply the particular accounting system to the communication, it is required that the mobile phone terminals on the sending and receiving sides locate within the respective specified areas.

Hence, in order to determine whether or not the communication using the particular accounting system is possible before the user of the mobile phone terminal on the sending side establishes the communication, it is necessary to know beforehand whether or not the mobile phone terminal on the receiving side locates within the specified area.

Furthermore, if the user of the mobile phone terminal can know that another mobile phone terminal locates within the area of which base station, the user can determine whether or not to allow him to meet another user of another mobile phone terminal and the ease of use or operability of the mobile communication system is raised for the users of the mobile phone terminals.

Hence, in this embodiment of the mobile communication system, as described hereinafter, the user of the mobile phone terminal can determine that other mobile phone terminals locate within the areas of which base stations, particularly, whether or not to locate within the respective specified areas.

In FIG. 18, there is shown one embodiment of a mobile phone terminal used in a mobile communication system according to a fourth preferable embodiment of the present invention. In this embodiment, a mobile phone terminal further includes a presence information storage 1019 besides the members of the mobile phone terminal of the first embodiment shown in FIG. 2. The presence information storage 1019 stores information representing each request for delivery of presence information of which mobile phone terminal and presence information of mobile phone terminals.

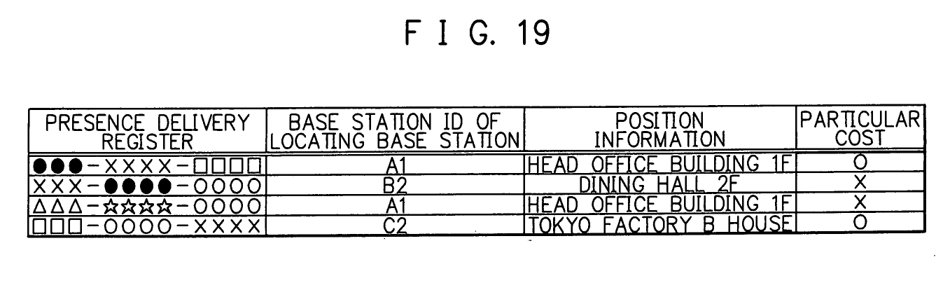

In FIG. 19, there is shown one embodiment of information stored in the presence information storage 1019 of the mobile phone terminal shown in FIG. 18. As illustrated, the presence information storage 1019 stores the information of combinations of terminal IDs representing each request of presence information of which mobile phone terminal and the presence information of the mobile phone terminals, wherein the presence information includes base station IDs of base stations that the mobile phone terminals locate, information showing positions or locations related to the base station IDs and information representing possibility or impossibility of communication using a particular accounting system. In the presence information storage 1019, the presence information is renewed every time when new presence information is received from the control server 300.

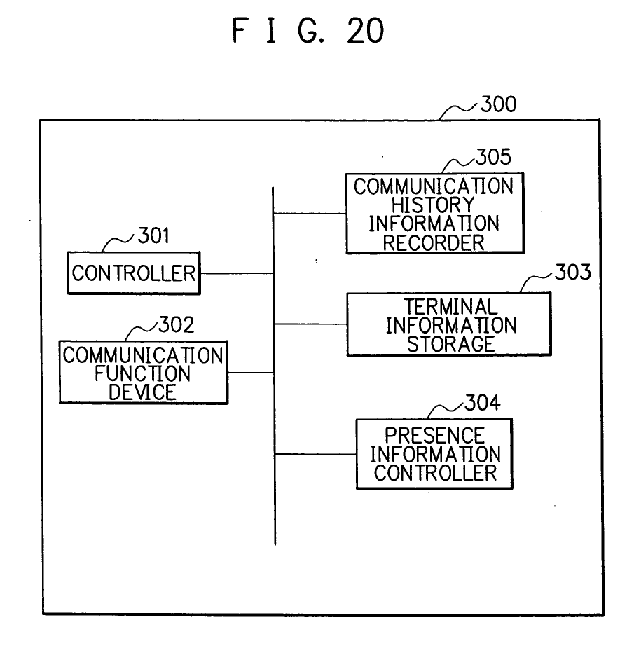

In FIG. 20, there is shown one embodiment of a control server 300 used in the mobile communication system according to the fourth embodiment of the present invention. In this embodiment, the control server 300 further includes a presence information controller 304 besides the members of the control server of the first embodiment shown in FIG. 5. The presence information controller 304 stores the presence information produced on the basis of the information stored in the terminal information storage 303 and produces new presence information when the information stored in the terminal information storage 303 is renewed. The presence information controller 304 holds position information related to each base station ID and can produce the position information corresponding to the base station ID as a part of the presence information.

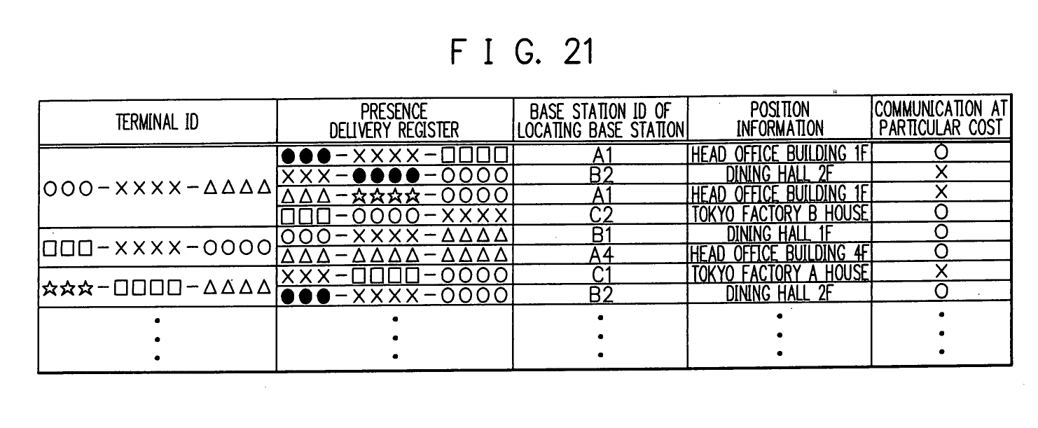

In FIG. 21, there is shown one embodiment of information stored in the presence information controller 304 of the control server 300 shown in FIG. 20. The presence information controller 304 stores information representing that each mobile phone terminal requests the presence information of which mobile phone terminal. As illustrated, this information includes combinations of terminal IDs of requesting mobile phone terminals, terminal IDs of mobile phone terminals that the delivery of the presence information is requested, and the presence information of the mobile phone terminals that the delivery of the presence information is requested, wherein the presence information includes the base station IDs of the base stations that the mobile phone terminals locate, the information showing the positions or locations related to the base station IDs and the information representing the possibility or impossibility of the communication using the particular accounting system.

In this embodiment, the user of each mobile phone terminal preregisters the information representing the request of the delivery of the presence information of which mobile phone terminal in the presence information controller 304 of the control server 300.

When one of the mobile phone terminals 101 to 105 moves from the prelocated area to the area of another base station and the position information such as the locating terminals stored in the terminal information storage 303 of the control server 300 is renewed, the presence controller 304 produces the position information of the respective mobile phone terminals on the basis of each base station ID of the base station that each mobile phone terminal locates. For instance, when the base station ID “A1” is related to the position information “home office building 1F”, as shown in FIG. 21, the presence controller 304 produces the position information “home office building 1F” with respect to the mobile phone terminal locating within the base station having the base station ID “A1”. Thereafter the controller 301 of the control server 300 sends the new presence information to the mobile phone terminal requesting the delivery of the presence information of the moved mobile phone terminal on the basis of the information registered in the presence information controller 304.

Now, assume the case that the presence information is sent to the mobile phone terminal 101 from the control server 300. In the mobile phone terminal 101, when receiving the presence information from the control server 300, the controller 1011 renews the information stored in the presence information storage 1019. When receiving the presence information from the control server 300, automatically or in response to an input operation of the user, the controller 1011 using the application in the communication application part 1012 executes to display the presence information on the display 1016 for presentation to user.

As described above, the user of the mobile phone terminal 101 can know the areas that other mobile phone terminals locate. In particular, when the user of the mobile phone terminal 101 carries out the communication with other mobile phone terminals 102 to 105, the user of the mobile phone terminal 101 can determine that the communication using the particular accounting system is either possible or impossible on the basis of the information that the target mobile phone terminals locate within the respective specified areas or out of the same.

In this embodiment, the operation of the communication that the particular accounting system is applied is the same as the first embodiment described above and the description thereof can be omitted for brevity.

In the above-described embodiment, although, when the mobile phone terminal receives the presence information from the control server, the presence information is displayed on the unshown display automatically or in response to the input operation of the user, the controller 1011 using the application in the communication application 1012 executes to display a list of selectable mobile phone terminals on the display 1016 on the basis of the information stored in the presence information storage 1019 when the user inputs the information carrying out the communication using the particular accounting system.

As described above, when the position information related to the base station ID obtained from each mobile phone terminal belonging to this base station is sent to other mobile phone terminals, for example, a juridical person office is provided with base stations on every floors and position information of mobile phone terminals owned by members of a company is sent to a control server. The control server delivers such position information of the mobile phone terminals owned by the members to the other mobile phone terminals, and all the members can hold the information representing whether or not a certain member stays within the office or on which floor the member stays in common.

In this embodiment, the presence information delivered to each mobile phone terminal is the information produced on the basis of the information representing that a certain mobile phone terminal locates within the area produced by which base station, and its accuracy depends on a base station basis or an area basis. Hence, by applying a base station having a smaller area to the mobile communication system, the accuracy of the presence information can be improved.

These embodiments described above are preferable examples of the present invention and hence the present invention is not restricted to those embodiments.

For instance, in each embodiment described above, although the communication application produced on the basis of any given application platform controls the operation of the mobile phone terminals, this is not restricted to the program control by the application and an exclusive DSP can be used for this control.

Furthermore, in the above-described embodiments, although the areas constituting the group have been arranged adjacent to each other, as in the case that each chain store of a store chain is provided with a base station, the areas constituting the group can be arranged away with distance.

While the present invention has been described with reference to the particular illustrative embodiments, it is not to be restricted by those embodiments but only by the appended claims. It is to be appreciated that those skilled in the art can change and modify the embodiments without departing from the scope and spirit of the present invention.

1. A mobile communication system, comprising:
a mobile communication network including a plurality of base stations;
mobile communication terminals assigned to any of the base stations, which carrying out communications via the mobile communication network; and
an accounting device for accounting communication costs to the communications of the mobile communication terminals, further comprising:
a control server connecting to all the base stations included in a group including at least one base station and to the accounting device, which applies a particular accounting system to a communication from any mobile communication terminal assigned to a specified base station included in the group to another mobile communication terminal assigned to the specified base station included in the group,
each mobile communication terminal including:
a first sending device for sending information showing the base station that its own terminal is assigned to the control server; and
a requesting device for requesting a communication with another mobile communication terminal using the particular accounting system from the control server,
the control server including:
first storage for storing terminal belonging information representing that any of the base stations included in the group is the specified base station for the respective mobile communication terminals;
second storage for storing terminal locating information representing the base station that the respective mobile communication terminals are now assigned to;
first determining part for determining whether or not the mobile communication terminals on sending and receiving sides are assigned to the respective base stations on the basis of the terminal belonging information and the terminal locating information stored in the first and second storage when the mobile communication terminal requests a start of the communication using the particular accounting system;
communication part for sending information representing that the communication using the particular accounting system is possible to the mobile communication terminal on the sending side when the mobile communication terminals on the sending and receiving sides are assigned to the respective specified base stations; and
transmitter for sending particular account applying information representing that the particular accounting system is applied to a communication cost of the communication using the particular accounting system to the accounting device when any mobile communication terminal carries out the communication using the particular accounting system.

2. A mobile communication system of claim 1, wherein the particular account applying information is information representing either exemption or reduction of the cost for the communication carried out by the mobile communication terminal.

3. A mobile communication system of claim 1, wherein the mobile communication terminal further includes:
a second sending device for sending a user identification specifying a user of his own mobile communication terminal when the mobile communication terminal requests the communication using the particular accounting system from the control server,
and the control server further includes:
register for storing user information representing that which of the base station included in the group is usable for each user as the specified base station; and
second determining part for determining whether or not the particular accounting system is applied to the communication of the mobile communication terminal requesting the communication using the particular accounting system on the basis of the user identification obtained from the mobile communication terminal.

4. A mobile communication system of claim 2, wherein the mobile communication terminal further includes:
a second sending device for sending a user identification specifying a user of his own mobile communication terminal when the mobile communication terminal requests the communication using the particular accounting system from the control server,
and the control server further includes:
register for storing user information representing that which of the base station included in the group is usable for each user as the specified base station; and
second determining part for determining whether or not the particular accounting system is applied to the communication of the mobile communication terminal requesting the communication using the particular accounting system on the basis of the user identification obtained from the mobile communication terminal.

5. A mobile communication system of claim 1, wherein the control server still further includes:
delivery part for delivering the terminal locating information related to any mobile communication terminal to another mobile communication terminal requesting the delivery of the terminal locating information.

6. A mobile communication system of claim 2, wherein the control server still further includes:
delivery part for delivering the terminal locating information related to any mobile communication terminal to another mobile communication terminal requesting the delivery of the terminal locating information.

7. A mobile communication system of claim 3, wherein the control server still further includes:
delivery part for delivering the terminal locating information related to any mobile communication terminal to another mobile communication terminal requesting the delivery of the terminal locating information.

8. A control server used for a mobile communication system comprising a mobile communication network including a plurality of base stations; mobile communication terminals assigned to any of the base stations, which carrying out communications via the mobile communication network; and an accounting device for accounting communication costs to the communications of the mobile communication terminals, the control server connecting to all the base stations included in a group including at least one base station and to the accounting device, the control server comprising:
first obtaining part for obtaining terminal locating information representing the base station that its own mobile communication terminal is assigned to from the respective mobile communication terminals;
first storage for storing terminal belonging information representing that any of the base stations included in the group is the specified base station for the respective mobile communication terminals;
second storage for storing the terminal locating information of the respective mobile communication terminals;
first determining part for determining whether or not the mobile communication terminals on sending and receiving sides are assigned to the respective base stations on the basis of the terminal belonging information and the terminal locating information stored in the first and second storage when the mobile communication terminal requests a start of a communication using a particular accounting system;
communication part for sending information representing that the communication using the particular accounting system is possible to the mobile communication terminal on the sending side when the mobile communication terminals on the sending and receiving sides are assigned to the respective specified base stations; and
transmitter for sending particular account applying information representing that the particular accounting system is applied to a communication cost of the communication using the particular accounting system to the accounting device when any mobile communication terminal carries out the communication using the particular accounting system,
the control server applying the particular accounting system to the communication from any mobile communication terminal assigned to the specified base station included in the group to another mobile communication terminal assigned to the specified base station included in the group.

9. A control server of claim 8, wherein the particular account applying information is information representing either exemption or reduction of the cost for the communication carried out by the mobile communication terminal.

10. A control server of claim 8, further comprising:
a second obtaining part for obtaining a user identification specifying a user of the mobile communication terminal from the mobile communication terminal requesting the communication using the particular accounting system;
a register for storing user information representing that which of the base station included in the group is usable for each user as the specified base station; and
a second determining part for determining whether or not the particular accounting system is applied to the communication of the mobile communication terminal requesting the communication using the particular accounting system on the basis of the user identification obtained from the mobile communication terminal.

11. A control server of claim 9, further comprising:
a second obtaining part for obtaining a user identification specifying a user of the mobile communication terminal from the mobile communication terminal requesting the communication using the particular accounting system;
a register for storing user information representing that which of the base station included in the group is usable for each user as the specified base station; and
a second determining part for determining whether or not the particular accounting system is applied to the communication of the mobile communication terminal requesting the communication using the particular accounting system on the basis of the user identification obtained from the mobile communication terminal.

12. A control server of claim 8, still further comprising:
a delivery part for delivering the terminal locating information related to any mobile communication terminal to another mobile communication terminal requesting the delivery of the terminal locating information.

13. A control server of claim 9, still further comprising:
a delivery part for delivering the terminal locating information related to any mobile communication terminal to another mobile communication terminal requesting the delivery of the terminal locating information.

14. A control server of claim 10, still further comprising:
a delivery part for delivering the terminal locating information related to any mobile communication terminal to another mobile communication terminal requesting the delivery of the terminal locating information.

15. A mobile communication method using a mobile communication system comprising a mobile communication network including a plurality of base stations; mobile communication terminals assigned to any of the base stations, which carrying out communications via the mobile communication network; an accounting device for accounting communication costs to the communications of the mobile communication terminals; and a control server for connecting to all the base stations included in a group including at least one base station and to the accounting device, and storing terminal belonging information representing that any of the base stations included in the group is the specified base station for the respective mobile communication terminals and terminal locating information representing the base station that the respective mobile communication terminals are now assigned to, comprising the steps of:
sending information showing the base station that its own terminal is assigned to the control server by the mobile communication terminal;
renewing the terminal locating information on the basis of the information obtained from the mobile communication terminal to register a position of the mobile communication terminal;
requesting a communication with another mobile communication terminal using a particular accounting system from the control server by the mobile communication terminal;
determining whether or not the mobile communication terminals on sending and receiving sides are assigned to the respective base stations on the basis of the terminal belonging information and the terminal locating information by the control server that the mobile communication terminal requests a start of the communication using the particular accounting system;
sending a message representing that the communication using the particular accounting system is possible to the mobile communication terminal on the sending side from the control server when the mobile communication terminals on the sending and receiving sides are assigned to the respective specified base stations;
establishing the communication with the mobile communication terminal on the receiving side by the mobile communication terminal having received the message from the control server; and
sending particular account applying information representing that the particular accounting system is applied to a communication cost of the communication carried out by the mobile communication terminal using the particular accounting system to the accounting device from the control server, thereby applying the particular accounting system to the communication from any mobile communication terminal assigned to the specified base station included in the group to another mobile communication terminal assigned to the specified base station included in the group.

16. A mobile communication method of claim 15, wherein the particular account applying information is information representing either exemption or reduction of the cost for the communication carried out by the mobile communication terminal.

17. A mobile communication method of claim 15, further comprising the following steps inserted before the determining step described above:
obtaining a user identification specifying a user of the mobile communication terminal from the mobile communication terminal requesting the communication using the particular accounting system by the control server; and
determining whether or not the particular accounting system is applied to the communication of the mobile communication terminal requesting the communication using the particular accounting system on the basis of user information representing that which of the base station included in the group is usable for each user as the specified base station and the user identification obtained from the mobile communication terminal, which are prestored in the control server.

18. A mobile communication method of claim 16, further comprising the following steps inserted before the determining step described above:
obtaining a user identification specifying a user of the mobile communication terminal from the mobile communication terminal requesting the communication using the particular accounting system by the control server; and
determining whether or not the particular accounting system is applied to the communication of the mobile communication terminal requesting the communication using the particular accounting system on the basis of user information representing that which of the base station included in the group is usable for each user as the specified base station and the user identification obtained from the mobile communication terminal, which are prestored in the control server.

19. A mobile communication method of claim 15, still further comprising the following step inserted after the registering step described above:
delivering the terminal locating information related to any mobile communication terminal to another mobile communication terminal requesting the delivery of the terminal locating information.

20. A mobile communication method of claim 16, still further comprising the following step inserted after the registering step described above:
delivering the terminal locating information related to any mobile communication terminal to another mobile communication terminal requesting the delivery of the terminal locating information.

21. A mobile communication method of claim 17, still further comprising the following step inserted after the registering step described above:
delivering the terminal locating information related to any mobile communication terminal to another mobile communication terminal requesting the delivery of the terminal locating information.
